(19) United States
(12) Patent Application Publication
(10) Pub. No.: US 2013/0212030 A1
(43) Pub. Date: Aug. 15, 2013

(54) METHOD OF VALUING A PATENT USING METRIC CHARACTERISTICS OF SIMILAR PATENTS GRANTED EARLIER

(71) Applicants: Mark T. Lane, Franklin, TN (US); G. Edward Powell, JR., Nashville, TN (US); N. edward White, Austin, TX (US)

(72) Inventors: Mark T. Lane, Franklin, TN (US); G. Edward Powell, JR., Nashville, TN (US); N. edward White, Austin, TX (US)

(21) Appl. No.: 13/371,696

(22) Filed: Feb. 13, 2012

(51) Int. Cl. G06Q 50/26

(52) U.S. Cl. 705/310

(57) ABSTRACT

A method of valuing a patent using metric characteristics of similar patents granted earlier, whereas said metrics comprise a variety of estimated future characteristics, normalized using estimated future market size. Similar patents are identified using a combination of one or more metric characteristics, for example, patent value estimate, semantic similarity, dependent claim counts, cited patent counts, word counts, patent counts within assigned classes/subclasses, and distinct assignee counts.

### BACKGROUND OF THE INVENTION

1. Field of the Invention

The present invention relates to the field of intellectual property valuation and, in particular, to methods of computer-assisted valuation of patents.

2. Description of the Related Art

One way to model the value of a patent is as a call option on the damages for not being granted a monopoly interest in the art described and claimed. Many automatic methods of estimating patent value tend to consider both: 1) Strength: the degree of adoption or likelihood of infringement of the art and 2) Market Size: the size of the associated market in order to establish a value estimate for a patent. Numerous techniques have been proposed for calculating the present value of a patent by trying to discern or estimate the above concepts relating to the invention. Many of these valuation techniques rely on the forward citations that a patent receives as an indication of the Strength. However, forward citations are lagging indicators of a patent's Strength and Market Size is a current factor.

There is a need therefore to identify patents that are likely to become valuable in the future while they are still early in their lifecycle. Based on the above notions, a patent is likely to become more valuable in the future because its associated technologies will achieve greater industry adoption or because the market to which it applies will grow in size, or both. This invention addresses the objective of predicting the future adoption of a patent by predicting a future number of forward citations, or a future number of distinct assignees. It also comprises the combination of predicting both the level of adoption and the future market size of a target patent, thereby better predicting a future patent value estimate for said target patent.

To accomplish this, this invention comprises the step of identifying a patent landscape of similar patents that represent likely growth scenarios for the target patent.

A helpful analogy is the use of growth charts for children. For example, a boy that is 51 inches tall when he is 7 years old is on track to be 74 inches tall when he is 18 years old. Likewise, a 51 inch 7 year old girl is on track to reach only 69 inches at 18 years of age. Just knowing the height of a child is not very useful, but additionally knowing that the child is a girl or boy in an a priori sense and selecting the appropriate growth landscape creates the ability to predict the future height more accurately. The present invention uses forward citations growth curves for patent landscapes that represent likely growth scenarios for a target patent.

As illustrated above, growth curves derived from landscape populations that are too generic can be improved with additional landscape filtering. In the case with patents, there are a variety of techniques that can be used to better construct a landscape of similar patents. For example, identifying all the patents in the same class or in the same sub-class as a target patent is one method of constructing a patent landscape. Other methods comprise the use of keyword searching, semantic matching, identifying patents assigned to a particular assignee, as well as identifying patents written by a particular patent attorney or reviewed by a particular USPTO patent examiner. Additionally, there are a variety of patent parameters that are static throughout a patent's life, and therefore comprise useful criteria when identifying similar patents within a patent landscape. These static parameters comprise: the number of independent and dependent claims, the number of cited patents, the time between filing and grant dates, length of independent claims, and the length of the abstract or the number of inventors.

### BRIEF SUMMARY OF THE INVENTION

Consider a patent p, which has not expired and resides within a patent landscape, and suppose that it is desired to estimate the value of the patent at some point in time in the future. There are four fundamental steps involved with obtaining this prediction:
1. The target patent p is identified and its historical metrics are gathered;
2. A landscape of patents with similar historical behavior to the target patent p is identified, and the historical metrics for each of the patents in said landscape are gathered;
3. The landscape of similar patents is further limited to comprise only those that are observable at the age that the patent p would be at a desired point in time in the future;
4. Statistical mean, median, mode, minimum, and/or maximum metric quantities are produced based upon the restricted set of patents gathered from the landscape.

### BRIEF DESCRIPTION OF THE DRAWINGS

FIG. 1 presents a functional overview of a simple preferred embodiment.

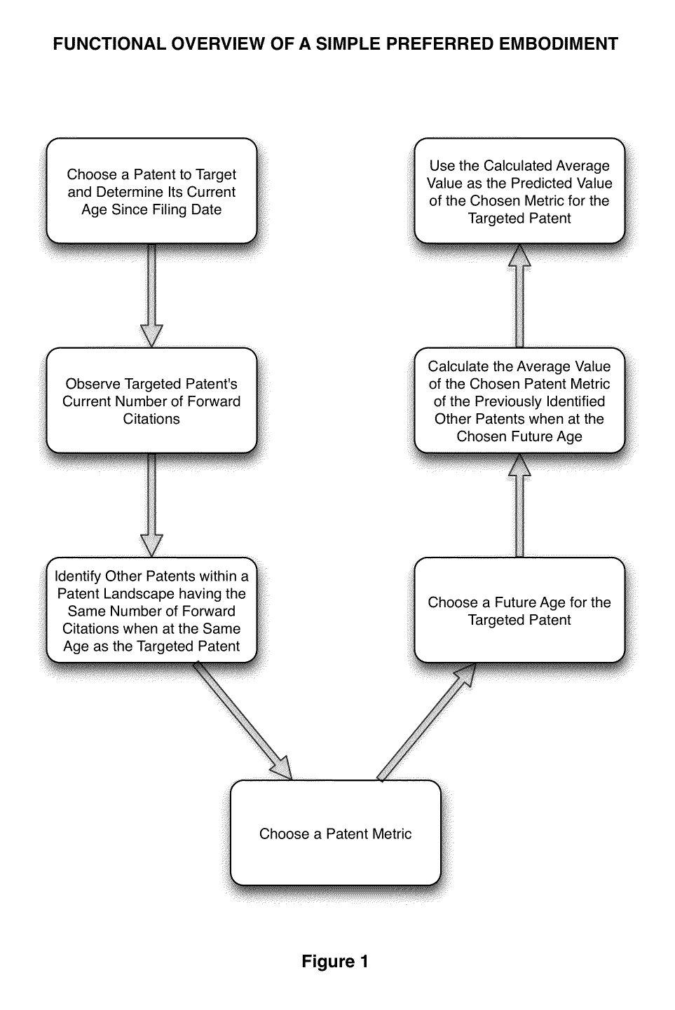

FIG. 2 presents a functional overview of a more sophisticated preferred embodiment.

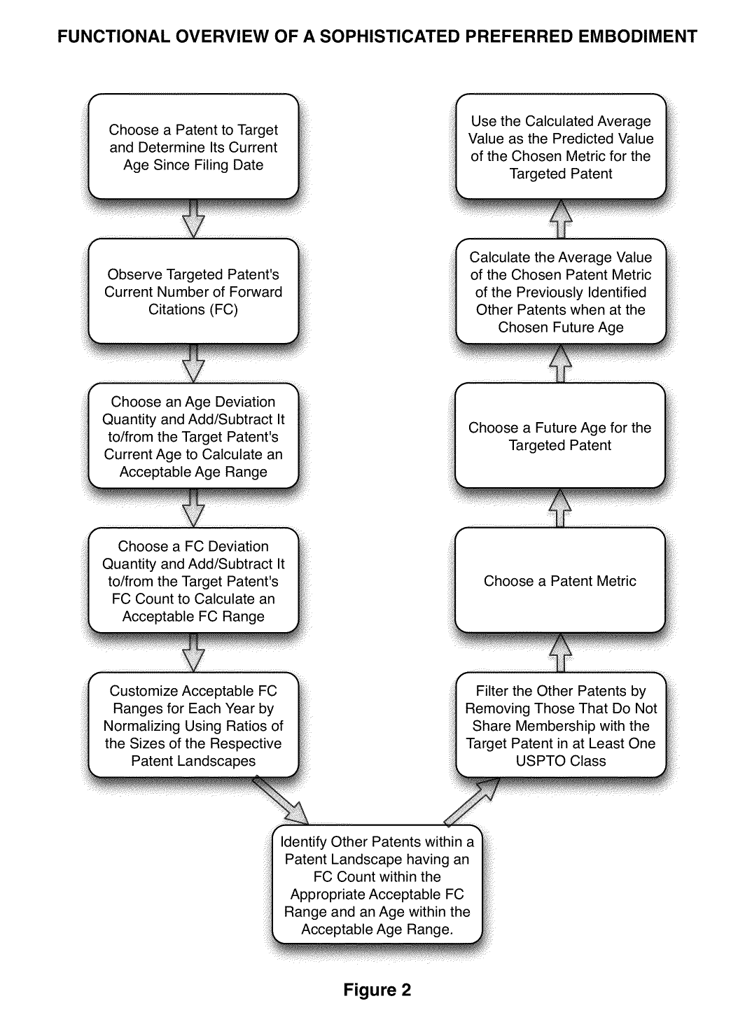

### DETAILED DESCRIPTION OF THE INVENTION

Define an “incestuous citation” to be a forward citation that is made by one or more of the same assignees as the patent being cited. This occurs with related patents and continuations, and it is important that we make a distinction between incestuous and non-incestuous citations in that non-incestuous citations tend to better reflect the degree of outside interest in the innovation. Within this specification, the term “forward citations” can be interpreted as referring to the number of non-incestuous citations.

Likewise, the term “forward citations” can alternatively be interpreted as referring to a “forward citation network score”, said score representing a value calculated by examining the forward citation tree that originates from a given patent.

During traversal a value is assigned to each forward citation based upon its distance in generations from the said given patent. For example, a patent can have a number of forward citations, each of which points to a patent which in turn can also have a number of forward citations. This forward citation tree is traversed for an arbitrary number of generations, and each citation is weighted according to its distance in generations from the patent to be scored. The weighted values are then summed to obtain a score that is assigned to said patent, said score representing a non-literal forward citation “count” value. Further, in another example, incestuous citations are culled during traversal, and/or their weighted values reduced.

Define “intrinsic value” to be a value derived by combining one or more metrics of a given patent. Note that the said one or more metrics are observed and/or calculated at a particular point in time. Hence, the “intrinsic value” of a given patent or patent metric may change as it ages.

Define “patent landscape” as an arbitrary collection of patents which can be interconnected via citations, for example the collection of all USPTO patents issued since 1960, or for example the collection of all unexpired EPO patents for a given year. Note that patent landscapes need not necessarily be restricted to just one country or patent office.

This invention can be used to predict the future value of any patent metric that can be observed and/or calculated. Examples include patent value estimate, number of forward citations, number of incestuous citations, weighted value of forward citation network, number of distinct citing entities, and number of distinct assignees.

Let year=1 be the issue year of any patent, year=2 be the next year, and so on. Suppose that at year N, the number of forward citations of the patent p is known to be k. Now consider all the patents in the grouping G of choice surrounding the patent p which were issued in a year prior to the issue year of the patent p, and compute from G all the patents that have a similar number of forward citations at their respective year N.

It is not necessary to consider only those that have exactly k citations at their respective year N, because a forward citation in a prior year is perhaps worth more because the patent landscape may have been smaller. To account for this, one can consider a range of forward citations based on the year in question and adjust the likely number of future forward citations based on the changing landscape. For example, suppose a patent p1 belongs to G and year N for the patent p is M years later than year N for the patent p1. Suppose the size of the patent landscape is s in year N for patent p and s1 in year N for patent p1. Compute the ratio r=k/s and calculate the quantities that are plus or minus x % of that ratio, where x is a input parameter selected by the practitioner. Then multiply the endpoint values that describe that range by the quantity s1 and take the integer part. This would then provide a proper range to see whether or not it contains the number of forward citations k1 for patent p1. If it does, then include the patent p1 in a sub-group, S, from which statistics can be computed.

Consider the following concrete example, which demonstrates the above technique: Suppose the patent p is granted in 2006 and has 5 citations in 2010 (year N=5). Suppose that a patent p1 was granted in 2000 and has 4 citations in 2004. If there are 3.9 Million patents in the landscape in 2010 and 3.1 Million patents in the landscape in 2004, then if we use x=10% to compute the selection criteria range, then the citations range would be 3 to 5 and the 4 citations of p1 would be in that range. The tighter the value of x that is used to compute an acceptable range of citations, the less are the number of patents that will pass and the statistical results in the sequel can be limited. If the value of x is greater, then more patents will pass, but the results may be noisy.

Now suppose that the subgroup S has been gathered consisting of all patents p1 in the group G such that the number of forward citations in year N passes the range test as described above. For every patent in S and for every year N+1 of each patent to the current year, compute the metrics for which we seek predicted values. To account for the differing sizes of the landscape in any given year, we then normalize these metric values using the sum of all the metric values of each type for each year that is in the patent landscape. Thus for each year from N+1 to the maximum observable year, there is a subset of patents from S that yield, for each patent in S, metrics

V={v_{N+1},v_{N+2},v_{N+3}, . . . ,v_{N+k}}

and from each of these subsets one can compute statistics such as minimum, maximum, mean, median, and standard deviation. It is preferable to normalized said metric quantities, V, by the patent landscape size, sᵢ, for individual year, to yield a correlated set of metrics

X={x_{N+1}=v_{N+1}/s_{N+1},x_{N+2}=v_{N+2}/s_{N+2},x_{N+3}=v_{N+3}/s_{N+3}, . . . ,x_{N+k}=v_{N+k}/s_{N+k}}

When said values are normalized as described above, then a statistical mean, or median plus or minus one standard deviation interval, can be used to calculate a range of predicted metric values as follows: If a value is desired for year N+m for some integer quantity, m, then for all patents in S where year N+m is observed, the desired statistical quantity, x, is calculated from all of the quantities x_{N+m}. When the target year N+m is less than or equal to the current year, then x can yield an appropriate estimate of the metric quantity v using

v=x*s_{N+m}.

When N+m is in the future, then x can yield an appropriate estimate of the metric v using

v=x*s_{N+k},

where k is the maximum integer so that the year N+k is equal to the current year. Moreover, when said interval describes the future, then one can also account for the net present value using a standard appreciation interest rate of growth to project that interval back to the present value for each metric.

This following paragraphs comprise a number of variations on the above-described method of estimating the future value of one or more metrics for a patent p using statistical techniques, namely:
Calculating an average future metric value,
Calculating a minimum and maximum future metric value, used for calculating a standard deviation and other statistical measures, and
Calculating a standard deviation of the forward citations and use that to assign a discount rate for calculating the present metric value.

The techniques for calculating these quantities are varied depending upon how the practitioner desires to group patents that have been granted earlier and have similar characteristics to the patent p at the observed age, such as:
Restrict the patent group to those that have one or more of the same classes as the target patent p,
Restrict the patent group to those that have one or more of the same classes/subclasses as the target patent p,
Restrict the patent group to those that have a percentage of the same classes as the target patent p,
Restrict the patent group to those that have a percentage of the same classes/subclasses as the target patent p,
Further restrict the patent group to those that also match one or more other metrics, and
Target a particular patent metric or set of metrics to predict from one of a list of several dynamic metrics of future patent valuation.

Suppose the patent p is selected that is at age L, as determined by application filing date, a date of first office action, a date of second office action, the issue date or expiration date, and determine the observed number of forward citations, k, at the current age L. Note that the age, if relative to the expiration date, can be negative. The objective is to compute a mean or a median value of the desired metric m at age D in the future. The metric m represents any unknown value, such as the number of forward citations received or a patent's estimated market value. The first step is to gather a group of patents with age greater than L that had similar landscape adjusted characteristics to the patent p, when said patents were at age L, where the behavior of each patent in the group is observable at age D. This means that a patent can belong to the group if the age D for that patent is before the current time and that patent is determined to have had a similar number for forward citations as the patent p when it was at age L.

Specifically, select two deviation parameters, σ₁ and σ₂, where either or both of the quantities can be 0. Patents whose target value metric is known at age D and whose number for forward citations is equal to k, plus or minus σ₁, at an age L, plus or minus σ₂ are gathered into a group. Once all such patents have been gathered, the future value metric for the patent p is then estimated by calculating an average of the value metrics for the patents in the group at their respective age D, where the average is calculated from the mean, median, or mode from the group. As described previously, the group of patents is then optionally further restricted to include only those that either intersect with a desired number of classes, or classes and subclasses, as the patent p, or those with a desired percentage of classes, or classes and subclasses.

The said group of patents is then optionally further restricted by applying a more detailed set of criteria, when compared with the characteristics of patent p. For example, one selects two additional deviation parameters, σ₃ and σ₄, where either or both of the quantities can be 0, and then restricts the statistical group to those patents which at age L, plus or minus σ₄, have a plus or minus deviation of σ₃ from one or more of the following metric characteristics:
patent value estimate,
semantic similarity score,
number of dependent claims,
number of cited patents,
number of days between the filing date and the notice of allowance date,
number of words in the first independent claim, number of class/subclasses to which the patent has been assigned,
patent count within the class/subclasses to which the patent has been assigned,
number of words in the abstract,
days remaining until expiration,
number of distinct assignees,
number of other high-value patents prosecuted by the prosecuting attorney, and
total value estimate of the class/subclasses to which the patent has been assigned.

Suppose the patent p is selected that is at age L, as determined by application filing date, a date of first office action, a date of second office action, the issue date, or the expiration date, and determine the observed number of forward citations, k, at the current age L. Note that the age, if relative to the expiration date, can be negative. The objective is to estimate a minimum and maximum value of the desired metric m at age D in the future, so that one can estimate a confidence interval containing the actual future value metric at age D. The confidence interval may be also optionally used to derive a discount rate to be applied when discounting predicted value to present value. The metric m represents any unknown quantity of value, such as the number of forward citations received or a patent value estimate. The first step is to gather a group of patents older than L that behaved similarly to the patent p when those patents were at age L and where the behavior of each patent in the group is observable at age D. This means that a patent can belong to the group if the age D for that patent is before the current time and that patent is determined to have a similar number for forward citations as the patent p when it was at age L.

Specifically, select two deviation parameters, σ₁ and σ₂, where either or both of the quantities can be 0. Patents whose target value metric is known at age D and whose number of forward citations is equal to k, plus or minus σ₁, at an age L, plus or minus σ₂ are gathered into a group. Once all such patents have been gathered, the minimum and maximum future value metrics for the patent p can be calculated using the patents in the group at their respective age D. As described previously, the group of patents is then optionally further restricted to include only those that either intersect with a desired number of classes, or classes and subclasses, as the patent p, or those with a desired percentage of classes, or classes and subclasses.

The said group of patents is then optionally further restricted by applying a more detailed set of criteria, when compared with the characteristics of patent p. For example, one selects two additional deviation parameters, σ₃ and σ₄, where either or both of the quantities can be 0, and then restricts the statistical group to those patents which at age L, plus or minus σ₄, have a plus or minus deviation of σ₃ from one or more of the following metric characteristics:
patent value estimate,
semantic similarity score,
number of dependent claims,
number of cited patents,
number of days between the filing date and the notice of allowance date,
number of words in the first independent claim,
number of class/subclasses to which the patent has been assigned,
patent count within the class/subclasses to which the patent has been assigned,
number of words in the abstract,
days remaining until expiration,
number of distinct assignees,
number of other high-value patents prosecuted by the prosecuting attorney, and
total value estimate of the class/subclasses to which the patent has been assigned.

Suppose the patent p is selected that is at age L. The objective is to compute the value of metric m at age D in the future. Using these quantities, one then calculates the present value of the metric m at L, as follows:

Value of m at L=Value of m at D/(1+r)ⁿ, where
n is the difference in age from D to L, in years, and
r is the discount rate.

One either sets r as a fixed rate, or calculates r from the confidence interval range as determined by the minimum and maximum value from the statistical group of patents. If the difference between the minimum and maximum values is large, then this means that the future value estimate is not that good and the discount rate, r, should be larger, and conversely a tighter confidence interval should not be discounted as much.

The present invention comprises a method for predicting characteristics of a patent at some point in the future. Because a patent has a finite life, and one of our intents is to use patent value metrics to help organizations monitor, manage and monetize their intellectual property, we have chosen for illustrative purposes to predict the value of a patent at a point 5 years prior to expiration.

The following comprises a preferred embodiment. Consider a patent p, which has not expired and resides within a patent landscape, where we desire to estimate a metric value of a patent, we are choosing to estimate that value 5 years prior to expiration (for simplicity, let's say, 15 years from filing for the patents considered). We first gather the number of forward citations, k, and the computed intrinsic value, v, at the current date.

Define an “offset” to be a number of years from file date. Let the offset for the current date and patent p be denoted by o. Group all patents by their distinct class lists that have an observable value 15 years from their respective file dates and have a similar number of forward citations at their respective offset years, o. Gather a subgroup, where a patent is allowed to belong to said subgroup if its actual number of forward citations is within 20% of the number observed for the patent p at offset o.

For example, if the offset o is 5 and the number of observed forward citations is 10, then all patents, where the 15th year from their respective file dates is less than or equal to the current date and where they share the same distinct class list as the patent p, are grouped together provided that, at age 5 years from the respective file dates, the patents had anywhere from 8 to 12 forward citations.

Suppose the number of forward citations for patents p at the current date, which happens to be in year N for p, is k and the size of the patent landscape (all patents granted) at the current date is s. We assume that we are considering a non-trivial situation where the 15th offset year for p is greater than the current date. Calculate the ratio

r=k/s,

and pick a selection range criterion, for example

x=20%=0.20.

Now, every patent p1 that shares the same distinct class list as p and where the 15th offset year is less than or equal to the current date is gathered, and the size of the patent landscape for the year N for p1 is calculated and denoted s1. For each such patent p1, calculate the ratio

r1=k1/s1,

and calculate plus and minus x % of the quantity r1:

r1(1−x) and r1*(1+x).

Then multiply both of these quantities by s and take the integer part to compute a range [ka, kb], where

ka=integer part of s*r1*(1−x) and kb=integer part of s*r1*(1+x).

If the number of forward citations, k, for p is contained in this interval [ka, kb], then p1 is a candidate and belongs to the statistical subgroup, S. The observed intrinsic value is then gathered for p1 at the 15th offset year (for p1), and this value is used in the computed average value to estimate the future value, E, for the 15th offset year (for p). Finally the future value E is discounted to the present using a discount rate, such as

i=11%=0.11,

as t=(E−v)/(1+i)ⁿ, where

n is the difference in age (in years) from the current date to 15 years from the file date for p.

The calculated metric value for the patent p is calculated as

mv=v+t.

We claim:

1. A method for predicting a future patent metric, comprising the steps of:
choosing a first age relative to a point in time selected from the group consisting of application date, first office action date, second office action date, issue date, and expiration date for a first patent;
determining the number of forward citations at said first age, for said first patent;
choosing a second age relative to a point in time selected from the group consisting of application date, first office action date, second office action date, issue date, and expiration date, to be targeted;
choosing a first deviation quantity, including zero;
choosing a second deviation quantity, including zero;
identifying by computer other patents within a patent landscape, with the same said number of forward citations plus or minus said first deviation quantity, when at the same said first age, plus or minus said second deviation quantity, as said first patent;
choosing a patent metric; and
predicting a future value at said second age, of said patent metric, for said first patent, by calculating an average value, using a method selected from the group consisting of mean, median, and mode, of said patent metric, at said second age, for said other patents.

2. The method of claim 1, wherein the step of identifying by computer other patents within a patent landscape, is further comprised of:
choosing a value N from the set of non-zero positive integers; and
restricting said other patents to those patents belonging to at least said value N number of the same classes to which said first patent belongs.

3. The method of claim 1, wherein the step of identifying by computer other patents within a patent landscape, is further comprised of:
choosing a value N from the set of non-zero positive integers; and
restricting said other patents to those patents belonging to at least said value N number of the same class-subclass combinations to which said first patent belongs.

4. The method of claim 1, wherein the step of identifying by computer other patents within a patent landscape, is further comprised of:
choosing a percentage value P; and
restricting said other patents to those patents belonging to at least said percentage value P of the same classes to which said first patent belongs.

5. The method of claim 1, wherein the step of identifying by computer other patents within a patent landscape, is further comprised of:
choosing a percentage value P; and
restricting said other patents to those patents belonging to at least said percentage value P of the same class-subclass combinations to which said first patent belongs.

6. The method of any one of claims 1-5, wherein the step of identifying by computer other patents within a patent landscape, is further comprised of:
choosing a third deviation quantity, including zero;
choosing a fourth deviation quantity, including zero; and
restricting said other patents to those patents which shared the same value, plus or minus said third deviation quantity, with said first patent, when at the same said first age, plus or minus said fourth deviation quantity, for one or more metrics selected from the group consisting of:
patent value estimate,
semantic similarity score,
number of dependent claims,
number of cited patents,
number of days between the filing date and the notice of allowance date,
number of words in the first independent claim,
number of class/subclasses to which the patent has been assigned,
patent count within the class/subclasses to which the patent has been assigned,
number of words in the abstract,
days remaining until expiration,
number of distinct assignees,
number of other high-value patents prosecuted by the prosecuting attorney, and
total value estimate of the class/subclasses to which the patent has been assigned.

7. The method of any one of claims 1-5, wherein the step of choosing a patent metric is further comprised of:
choosing a patent metric selected from the group consisting of:
patent value estimate,
number of forward citations,
number of incestuous citations,
forward citation network score,
number of distinct citing entities, and
number of distinct assignees.

8. The method of claim 6, wherein the step of choosing a patent metric is further comprised of:
choosing a patent metric selected from the group consisting of:
patent value estimate,
number of forward citations,
number of incestuous citations,
forward citation network score,
number of distinct citing entities, and
number of distinct assignees.

9. The method of any one of claims 1-5, wherein the step of identifying by computer other patents within a patent landscape, is further comprised of:
calculating a normalization factor for each candidate member of the set of said other patents, by dividing a first size of said patent landscape when said first patent is at said first age, by a second size of said patent landscape when said candidate member to be identified is at said first age; and
multiplying the initial value of said first deviation quantity by said normalization factor prior to each use.

10. The method of claim 6, wherein the step of identifying by computer other patents within a patent landscape, is further comprised of:
calculating a normalization factor for each candidate member of the set of said other patents, by dividing a first size of said patent landscape when said first patent is at said first age, by a second size of said patent landscape when said candidate member to be identified is at said first age; and
multiplying the initial value of said first deviation quantity by said normalization factor prior to each use.

11. The method of claim 7, wherein the step of identifying by computer other patents within a patent landscape, is further comprised of:
calculating a normalization factor for each candidate member of the set of said other patents, by dividing a first size of said patent landscape when said first patent is at said first age, by a second size of said patent landscape when said candidate member to be identified is at said first age; and
multiplying the initial value of said first deviation quantity by said normalization factor prior to each use.

12. The method of claim 8, wherein the step of identifying by computer other patents within a patent landscape, is further comprised of:
calculating a normalization factor for each candidate member of the set of said other patents, by dividing a first size of said patent landscape when said first patent is at said first age, by a second size of said patent landscape when said candidate member to be identified is at said first age; and
multiplying the initial value of said first deviation quantity by said normalization factor prior to each use.

13. A method for predicting a future patent metric, comprising the steps of:
choosing a first age relative to a point in time selected from the group consisting of application date, first office action date, second office action date, issue date, and expiration date, for a first patent;
determining the number of forward citations at said first age, for said first patent;
choosing a second age relative to a point in time selected from the group consisting of application date, first office action date, second office action date, issue date, and expiration date, to be targeted;
choosing a first deviation quantity, including zero;
choosing a second deviation quantity, including zero;
identifying by computer other patents within a patent landscape, with the same said number of forward citations plus or minus said first deviation quantity, when at the same said first age, plus or minus said second deviation quantity, as said first patent;
choosing a patent metric;
predicting a minimum future value at said second age, of said patent metric, for said first patent, by selecting the minimum value of said patent metric, from said other patents, at said second age; and
predicting a maximum future value at said second age, of said patent metric, for said first patent, by selecting the maximum value of said patent metric, from said other patents, at said second age.

14. A method for estimating present patent value, comprising the steps of:
determining a future value for a first patent;
assigning a present intrinsic value to said first patent,
calculating a first intermediate value, by subtracting said present intrinsic value from said future value of said first patent;
choosing a discount rate;
calculating a second intermediate value, by discounting said first intermediate value using said discount rate; and
estimating a present value for said first patent, by adding said second intermediate value to said present intrinsic value.
